(19) United States
(12) Patent Application Publication
(10) Pub. No.: US 2014/0376517 A1
(43) Pub. Date: Dec. 25, 2014

(54) OPPORTUNISTIC ACTIVATION OF RELAYS IN CLOUD RADIO ACCESS NETWORKS

(71) Applicant: QUALCOMM Incorporated, San Diego, CA (US)

(72) Inventors: Stefan GEIRHOFER, Brooklyn, NY (US); Alan BARBIERI, San Diego, CA (US); Naga BHUSHAN, San Diego, CA (US); Peter GAAL, San Diego, CA (US)

(21) Appl. No.: 14/313,436

(22) Filed: Jun. 24, 2014

Related U.S. Application Data
(60) Provisional application No. 61/839,317, filed on Jun. 25, 2013.

(51) Int. Cl. H04W 36/30

(52) U.S. Cl. CPC H04W 36/30
USPC 370/332

(57) ABSTRACT

According to example embodiments, a method for wireless communications includes identifying at least one UE capable of being served by a plurality of transmission points (TPs) on a first frequency or by a relay on a second frequency, evaluating a first performance metric conditioned on the UE being served by the relay and a second performance metric conditioned on the UE being served by the plurality of TPs, deciding whether the UE should be served by the plurality of TPs on the first frequency or by the relay on the second frequency, based, at least in part, on the first and second performance metrics, and taking action to switch the UE to or from being served by the relay or the plurality of TPs, based on the decision.

### CROSS-REFERENCE TO RELATED APPLICATIONS

The present application for patent claims priority to U.S. Provisional Application No. 61/839,317, filed Jun. 25, 2013, which is assigned to the assignee of the present application and hereby expressly incorporated by reference herein in its entirety.

### FIELD

Certain aspects of the disclosure generally relate to wireless communications and, more particularly, to techniques for managing opportunistic activation of relays in cloud radio access networks (RANs).

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

Certain aspects of the present disclosure provide techniques, corresponding apparatus, and program products, for managing opportunistic activation of relays in cloud radio access networks (RAN).

Certain aspects provide a method for wireless communications. The method generally includes identifying at least one UE capable of being served by a plurality of transmission points (TPs) on a first frequency or by a relay on a second frequency, evaluating a first performance metric conditioned on the UE being served by the relay and a second performance metric conditioned on the UE being served by the plurality of TPs, deciding whether the UE should be served by the plurality of TPs on the first frequency or by the relay on the second frequency, based, at least in part, on the first and second performance metrics, and taking action to switch the UE to or from being served by the relay or the plurality of TPs, based on the decision.

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network, in accordance with certain aspects of the present disclosure.

FIG. 2A shows an example format for the uplink in Long Term Evolution (LTE), in accordance with certain aspects of the present disclosure.

FIG. 3 shows a block diagram conceptually illustrating an example of a Node B in communication with a user equipment device (UE) in a wireless communications network, in accordance with certain aspects of the present disclosure.

FIG. 4 illustrates an example heterogeneous network (HetNet), in accordance with certain aspects of the present disclosure.

FIG. 5 illustrates example resource partitioning in a heterogeneous network, in accordance with certain aspects of the present disclosure.

FIG. 6 illustrates example cooperative partitioning of subframes in a heterogeneous network, in accordance with certain aspects of the present disclosure.

FIG. 7 illustrates an example scenario of a Coordinated MultiPoint (CoMP) transmission, in accordance with certain aspects of the present disclosure.

FIG. 8 illustrates another example scenario of a Coordinated MultiPoint (CoMP) transmission, in accordance with certain aspects of the present disclosure.

FIG. 9 illustrates an exemplary architecture, in accordance with aspects of the present disclosure.

FIG. 10 illustrates Multi Point Equalization (MPE), in accordance with aspects of the present disclosure.

FIG. 11 illustrates example operations that may be performed, for example, by a base station, in accordance with aspects of the present disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

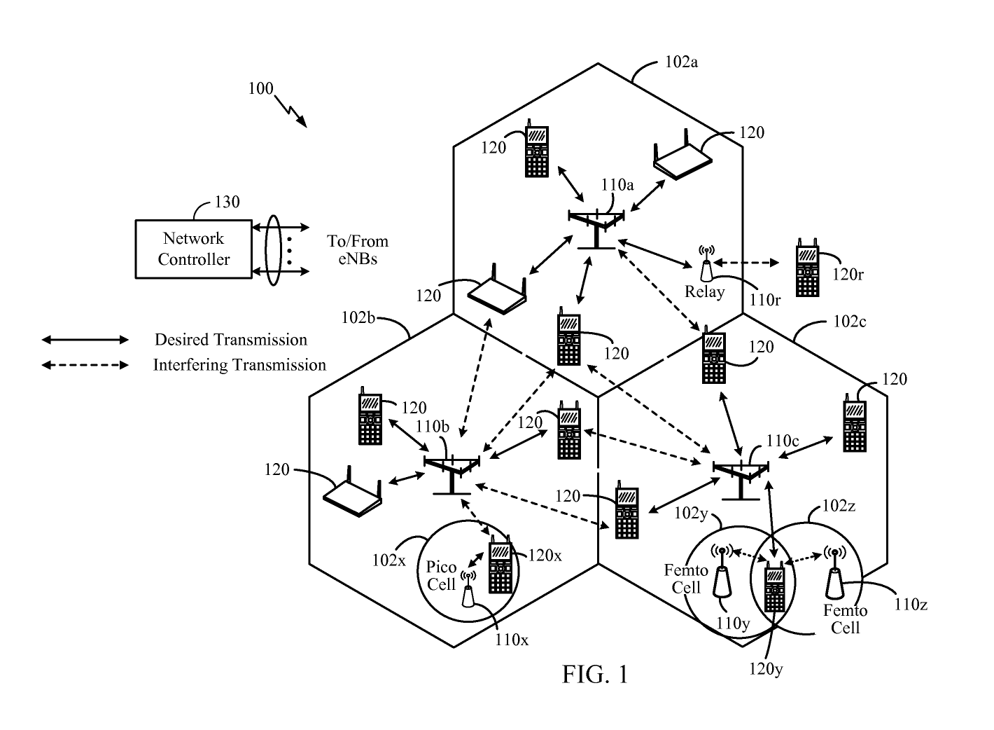

FIG. 1 shows a wireless communication network 100, in which aspects of the present disclosure may be practiced.

Wireless communication network 100 may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations (i.e., relays). A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs.

According to aspects of the present disclosure, relays may be referred to as “opportunistic” relays because they may be opportunistically selected and activated to relay transmissions to UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

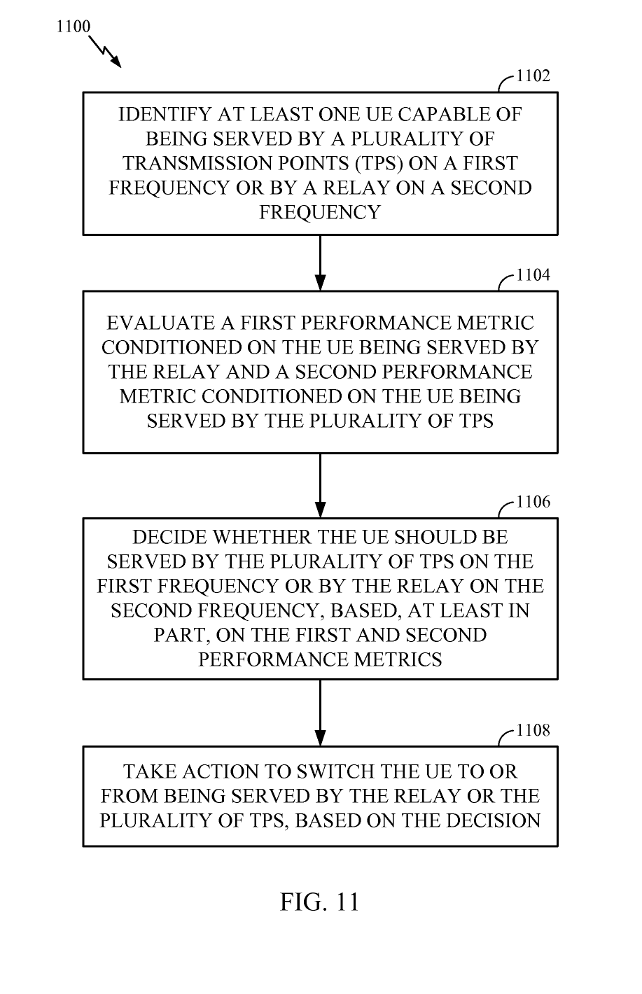

A network controller 130 may couple to a set of eNBs and provide coordination and control for these eNBs. The network controller 130 may communicate with eNBs 110 via a backhaul. According to aspects of the present disclosure, a network controller or an eNB may perform the various processes and operations disclosed, such as operations 1100 illustrated in FIG. 11. One or more processors in a network controller or eNB may direct the network controller or eNB in carrying out the various processes and operations disclosed. A memory or other processor-readable or computer-readable medium may comprise instructions for processors to execute in directing or performing the various processes and operations disclosed. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

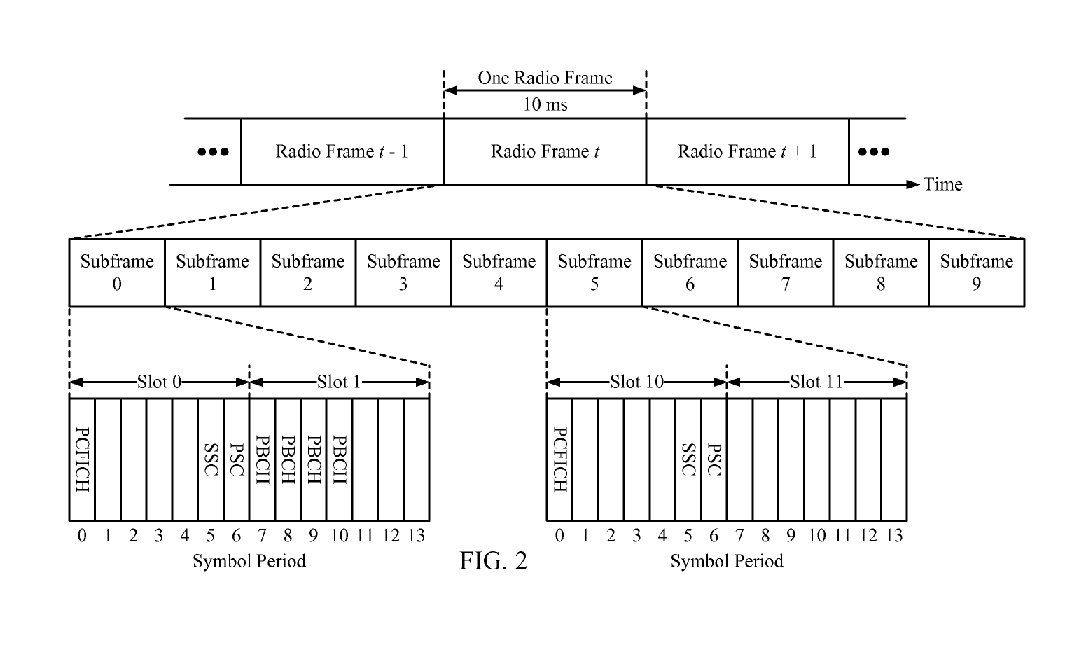

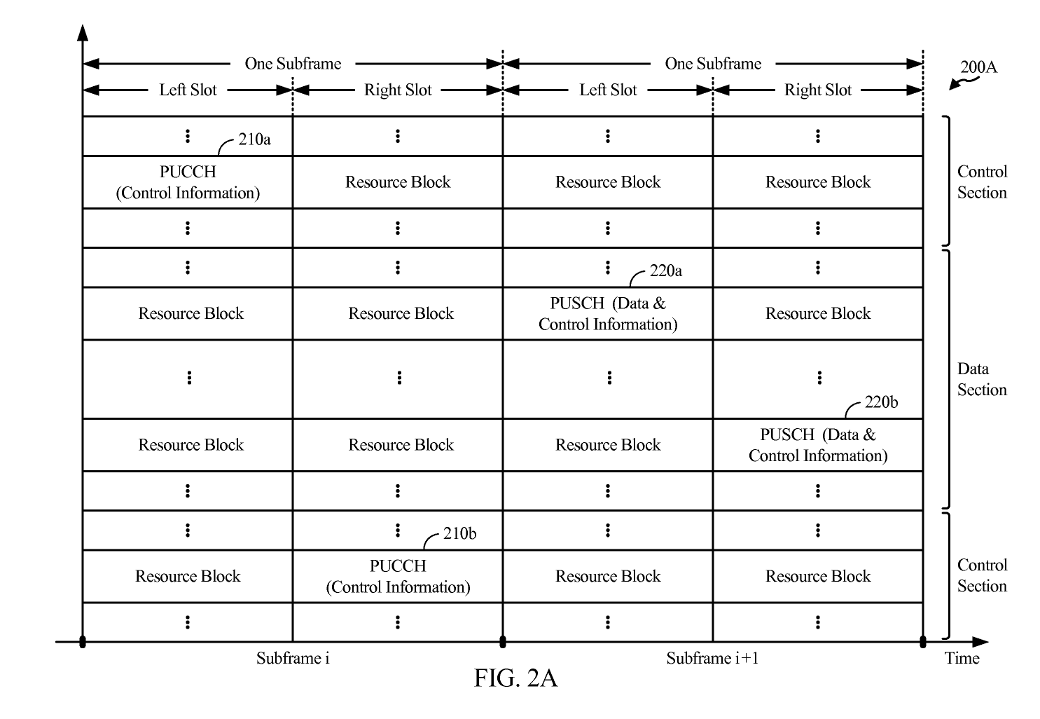

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

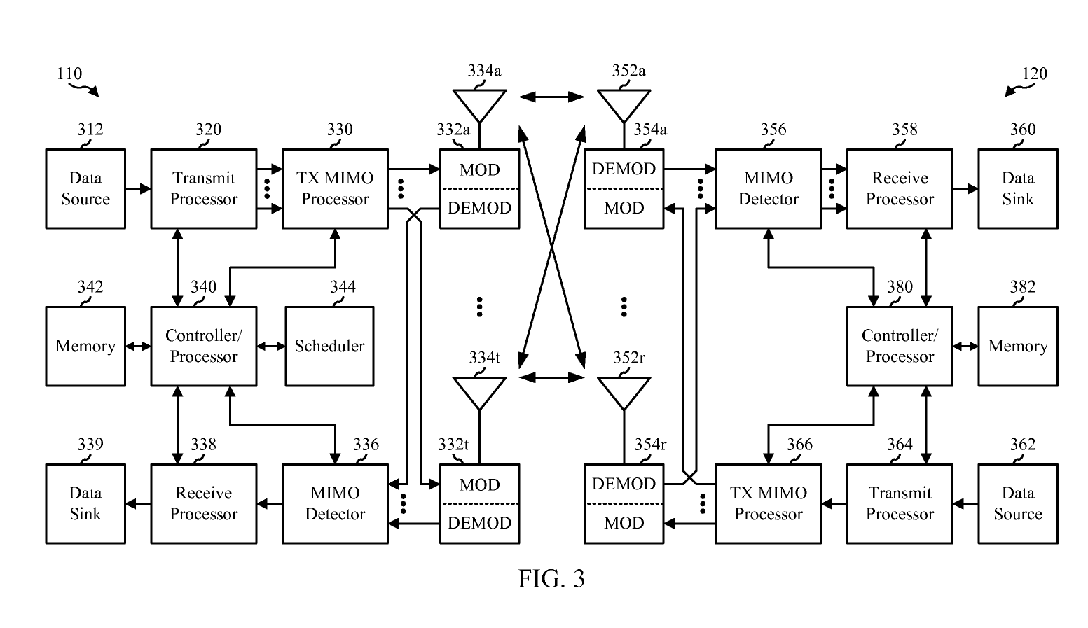

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

The controllers/processors 340 and 380 may direct the operation at the eNB 110 and the UE 120, respectively. The controller/processor 340, receive processor 338, and/or other processors and modules at the eNB 110 may perform or direct operations 1100 in FIG. 11 and/or other processes for the techniques described herein. The memories 342 and 382 may store data and program codes for the eNB 110 and the UE 120, respectively. The memory 342 may, for example, store program codes for performing the operations 1100 in FIG. 11. A scheduler 344 may schedule UEs for data transmission on the downlink and/or uplink. The scheduler 344 may also perform or direct operations 1100 in FIG. 11 and/or other processes for the techniques described herein.

### Example Resource Partitioning

According to certain aspects of the present disclosure, when a network supports enhanced inter-cell interference coordination (eICIC), base stations of the network may negotiate with each other to coordinate resources in order to reduce or eliminate interference. Interference may be reduced by one or more interfering cells giving up part of their resources. In accordance with this interference coordination, a UE may be able to access a serving cell even with severe interference by using resources yielded by an interfering cell.

For example, a femto cell operating in the coverage area of a macro cell may be able to create a “coverage hole” in the femto cell's own coverage area for the macro cell by yielding resources and effectively removing interference. The femto cell may be operating in a closed access mode, i.e., only allowing UEs which are members of an appropriate closed subscriber group to access the femto cell. If the macro cell is open access, i.e., allowing any UE with a network subscription to access it, then by negotiating for the femto cell to yield resources, the macro cell may enable a UE under the femto cell coverage area that is not a member of the femto cell's closed subscriber group to access the macro cell using the yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some time periods (e.g., subframes) in the time domain. When the coordinated resource partitioning is frequency based, the interfering cell may yield subcarriers in the frequency domain. When the coordinated resource partitioning is both frequency and time based, the interfering cell may yield certain frequency resources during certain time periods (e.g., subframes).

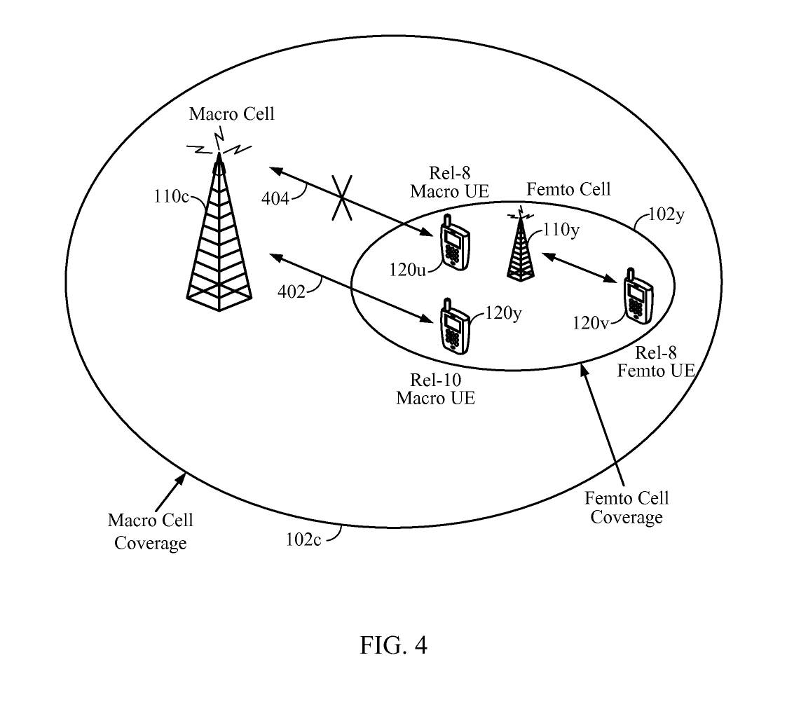

FIG. 4 illustrates an example scenario where eICIC may allow a UE 120y supporting eICIC (e.g., a Rel-10 macro UE as shown in FIG. 4) to access the macro cell 110c even when the UE 120y is experiencing severe interference from the femto cell y, as illustrated by the solid radio link 402. A legacy UE 120u (e.g., a Rel-8 UE as shown in FIG. 4) may not be able to access the macro cell 110c under severe interference from the femto cell 110y, as illustrated by the broken radio link 404. A UE 120v (e.g., a Rel-8 UE as shown in FIG. 4) may access the femto cell 110y without any interference problems from the macro cell 110c.

According to certain aspects, networks may support eICIC utilizing different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be conveyed to a UE so that the UE can use the resource partitioning information for the UE's own operations.

As examples, resource partitioning may be implemented with 8 ms periodicity (8 subframes) or 40 ms periodicity (40 subframes). According to certain aspects, frequency division duplexing (FDD) may also be applied such that frequency resources may also be partitioned. For communications via the downlink (e.g., from a node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index, Index_{sRPI}_{_{—}}_{DL} ranging from 0 to 7 and defined by the below equation:

Index_{SRPI}_{_{—}}_{DL}=(SFN*10+subframe number)mod 8

For the uplink, the SRPI mapping may be shifted from the downlink mapping, for example, by 4 subframes. Thus, an example index, Index_{SPRI}_{_{—}}_{UL}, for the uplink may be defined by the below equation:

Index_{SPRI}_{_{—}}_{uL}=(SFN*10+subframe number+4)mod 8

SRPI may use the following three values for each entry:

| Value | Name | Notes |
|---|---|---|
| U | Use | This value indicates the subframe has been |
| | | reserved to be used by this cell and will not be |
| | | subject to dominant interference (i.e., the main |
| | | interfering cells do not use this subframe). |
| N | No Use | This value indicates the subframe shall not be |
| | | used by this cell (i.e., other cells may be using |
| | | this subframe and should not receive |
| | | interference from this cell). |
| X | Unknown | This value indicates the subframe is not |
| | | statically partitioned. Details of resource usage |
| | | negotiation between base stations for this |
| | | subframe may not be known to the UE. |

Another possible set of parameters for SRPI may be the following:

| Value | Name | Notes |
|---|---|---|
| U | Use | This value indicates the subframe has been |
| | | reserved to be used by this cell and will not be |
| | | subject to dominant interference (i.e., the main |
| | | interfering cells do not use this subframe). |
| N | No Use | This value indicates the subframe shall not be |
| | | used by this cell (i.e., other cells may be using |
| | | this subframe and should not receive |
| | | interference from this cell). |
| X | Unknown | This value indicates the subframe is not |
| | | statically partitioned. Details of resource usage |
| | | negotiation between base stations for this |
| | | subframe are not known to the UE. |
| C | Common | This value may indicate all cells may use this |
| | | subframe without resource partitioning. This |
| | | subframe may be subject to interference, so |
| | | that the base station may choose to schedule |
| | | this subframe only for a UE that is not |
| | | experiencing severe interference. |

A serving cell's SRPI may be broadcast by the cell. In E-UTRAN, the SRPI of the serving cell may be transmitted in a master information block (MIB), or in a system information block (SIB). One or more sets of SRPI may be predefined based on characteristics of cells, e.g. macro cell, pico cell with open access, and femto cell with closed access. In such a case, the predefined sets of SRPI may be encoded by, for example, defining a set of indices with each index referring to a predefined SRPI. Transmission of an index may result in more efficient broadcasting of the SRPI in the system overhead message over the air, in comparison to broadcasting an entire SRPI.

A base station may also broadcast a neighbor cell's SRPI (i.e., an entire SRPI or an SRPI index) in a SIB. To broadcast a neighbor cell's SRPI, a base station may transmit the neighbor cell's SRPI with the neighbor cell's corresponding physical cell identity (PCI) or range of PCIs. For example, a base station may receive SRPI from a neighboring cell over a backhaul connection, and transmit a list of the neighboring cell's PCIs and an index to the neighbor cell's SRPI in a SIB. In a second example, a base station may receive a first SRPI from two neighboring cells via a backhaul connection, and a second SRPI from a third neighboring cell. In the second example, the base station may transmit PCIs for the first two neighboring cells associated with an index of the first SRPI and PCI(s) for the third neighboring cell associated with an index of the second SRPI in a SIB or SIBs.

ARPI may represent additional resource partitioning information including detailed information for the Unknown (‘X’) subframes in SRPI. As noted above, detailed information for the ‘X’ subframes is typically possessed only by base stations, and a UE typically does not possess it.

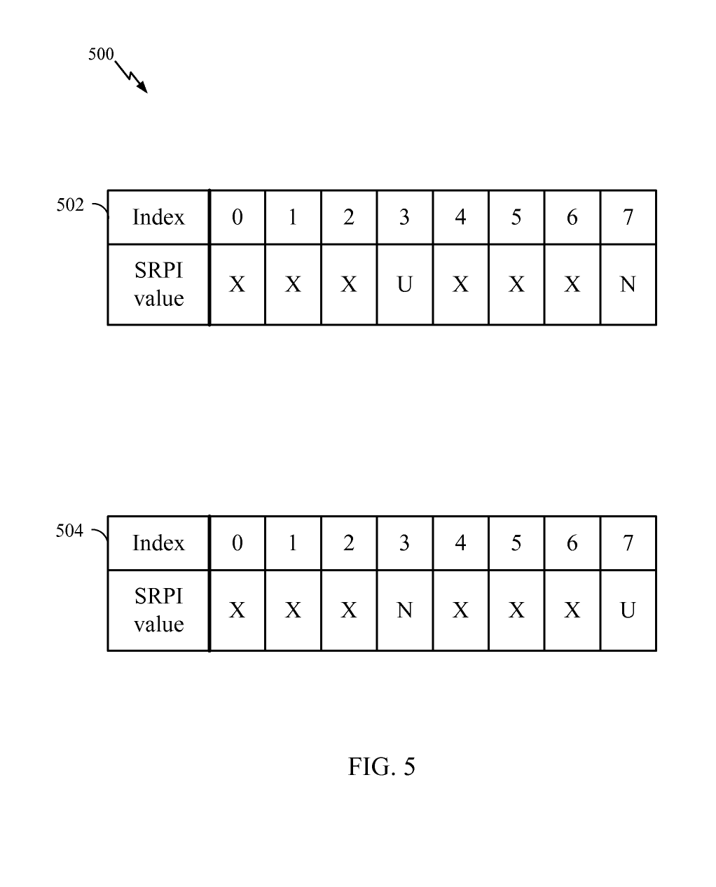

FIG. 5 illustrates examples 500 of SRPI assignments in a resource partitioning scenario involving macro and femto cells. Exemplary SRPI assignments for a macro cell are shown at 502. Exemplary SRPI assignments for a femto cell are shown at 504. A U, N, X, or C subframe is a subframe corresponding to a U, N, X, or C SRPI assignment.

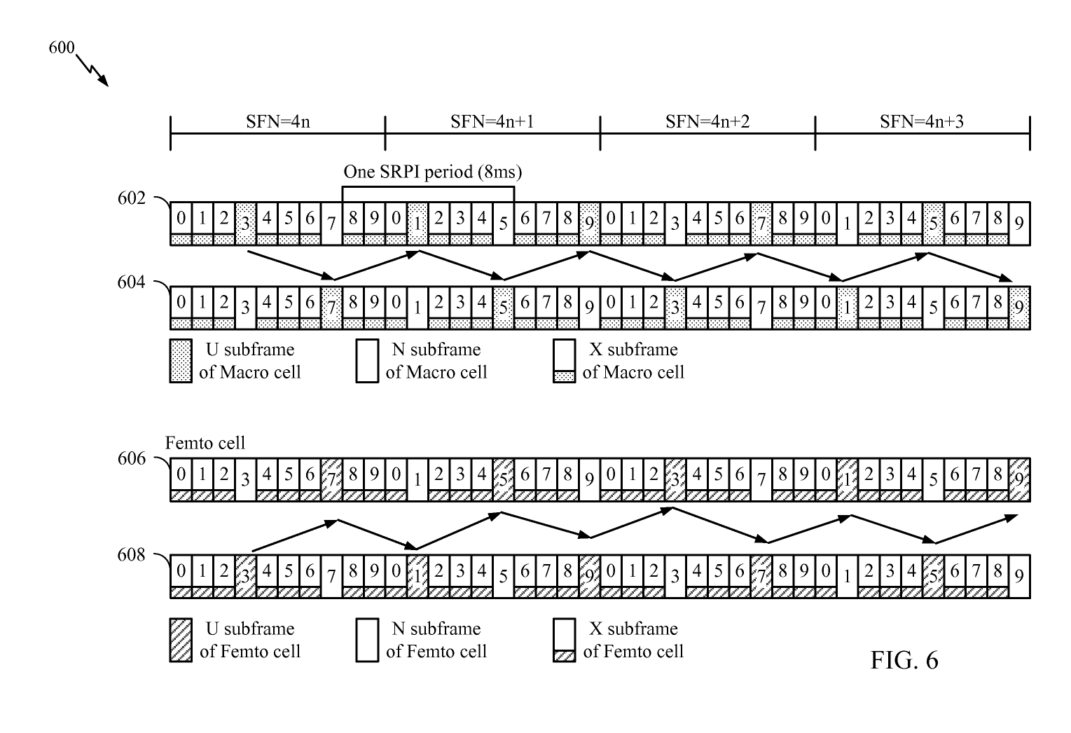

FIG. 6 illustrates examples 600 of SRPI assignments in a resource partitioning scenario involving macro and femto cells operating with FDD. Exemplary SRPI assignments for the downlink for a macro cell are shown at 602, and the corresponding SRPI assignments for the uplink are shown at 604. Exemplary SRPI assignments for the downlink for a femto cell are shown at 606, and the corresponding SRPI assignments for the uplink are shown at 608. A U, N, X, or C subframe is a subframe corresponding to a U, N, X, or C SRPI assignment.

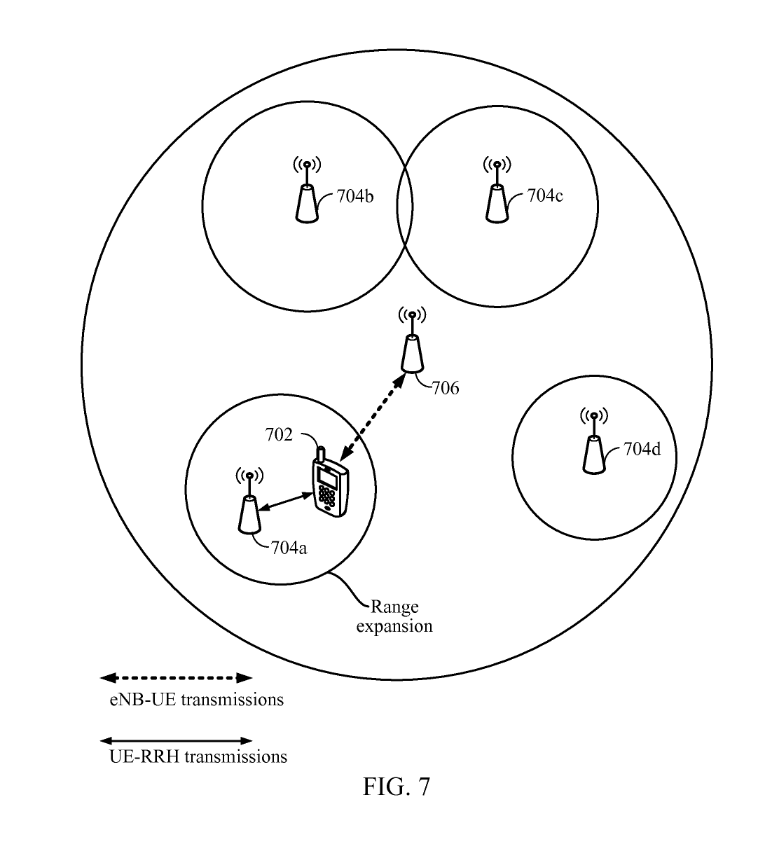

FIG. 7 illustrates an example scenario of a CoMP transmission, in accordance with certain aspects of the present disclosure. As seen in FIG. 7, the UE 702 is much closer to RRH 704a than to eNB 706 and may transmit data and/or control to RRH 704a. It may therefore be more efficient (e.g., UE 702 may transmit to RRH 704a using less power than required for UE 702 to transmit to eNB 706) for UE 702 to be served by RRH 704a on the uplink.

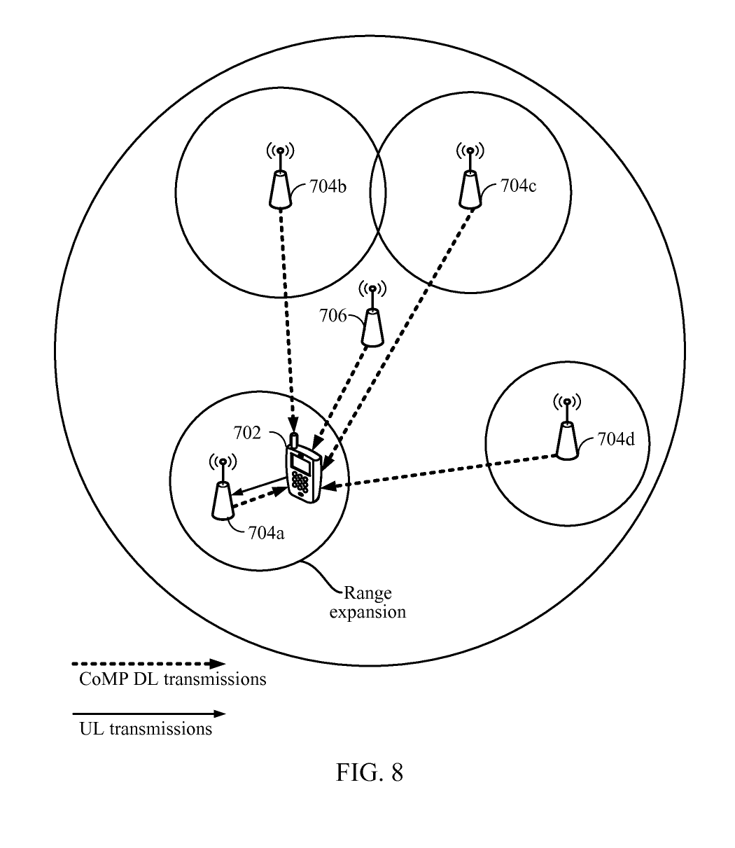

FIG. 8 illustrates another example scenario of a Coordinated MultiPoint (COMP) transmission, in accordance with certain aspects of the present disclosure. As seen in FIG. 8, downlink (DL) signals are transmitted to UE 702 from one macro cell (eNB 706) and four picocells (RRH 704a, RRH 704b, RRH 704c, and RRH 704d), but uplink (UL) transmissions are received only by RRH 704a, since RRH 704a is closer to UE 702 than RRH 704b, RRH 704c, RRH 704d, and eNB 706.

### Example Opportunistic Activation of Relays in Cloud Radio Access Network

Wireless networks have seen tremendous growth in recent years, largely fueled by the rapid proliferation of smartphones. This trend will likely continue unabated, and industry reports suggest an approximate doubling of data demand every year.

In order to accommodate this rapid growth, wireless operators may enhance their wireless networks in multiple ways. One technique has been cell densification, which seeks to bring cells closer to the user by deploying low power “pico cells” on top of an existing macro network. The reduced transmit power of pico cells may avoid issues relating to pilot pollution, while the layer of macro cells continues to ensure that network coverage is not compromised in areas outside of pico cell coverage. A network consisting of cells of differing power levels and capabilities, such as macro cells and pico cells, is referred to as a heterogeneous network (HetNet).

Interference coordination may significantly improve gains achieved in heterogeneous networks, as without interference coordination the coverage of pico cells is severely limited by interference from the macro cells. The concept of cell-range expansion (CRE) has also demonstrated significant gains. It relies on the technique of blanking macro cell transmission on certain subframes, so-called almost-blank-subframes (ABS), and interference cancellation of common reference signals, such as the cell-specific reference signal (CRS) in LTE. Used together, CRS interference cancellation increases pico cell coverage, while ABS subframes enable multiple pico cells to serve UEs simultaneously without creating significant interference to each other. While the macro cell does not schedule any users in ABS subframes, the fact that multiple pico cells can utilize these subframes simultaneously may more than compensate for the loss of the use of these subframes by the macro cell.

The coordination of ABS subframes between cells, often referred to as resource partitioning, may require coordination at a slow timescale between the cells in the network. Interference coordination between cells can be performed on a faster timescale when a fast, e.g., fiber based, backhaul is available. Such coordination schemes may further rely on feedback of channel state information (CSI) from multiple cells and are referred to as Coordinated Multi Point Transmission (CoMP) or Network MIMO.

CoMP has received significant attention, in both academia and industry, and support of such operation was recently introduced in LTE Release 11. The gains associated with Rel-11 CoMP have fallen short of expectations and amount to balancing performance among cell-center and cell-edge users more than meaningful capacity gain. A reason for this surprising outcome may be that studies projecting capacity gains when using CoMP have mostly focused on simple joint transmission schemes wherein multiple cells transmit to a single UE. By focusing on the simple joint transmission schemes, the studies may have failed to consider scheduling dimensions in their capacity analyses.

According to certain aspects, a cell with multiple transmission points (TPs) may perform coherent interference nulling, while scheduling as many UEs as would be scheduled in single-cell operation. This has the potential for significant gains in highly dense scenarios, where interference cannot otherwise be mitigated. This technique will be referred to as Multi Point Equalization (MPE).

MPE gains may be most significant in situations wherein a UE receives interference from several strong cells. By reporting CSI for the several strong interfering cells and performing interference nulling, high signal to interference and noise ratio (SINR) conditions can be achieved post coordination. However, the number of significant interferers needs to be small enough to allow a UE to report CSI for all of them. Significant interferers for which CSI cannot be accurately measured may therefore represent a limiting factor to achievable MPE performance.

Opportunistic relays have evolved separately from the interference coordination techniques described above. The premise of opportunistic relaying is to use either an actual UE, or a low power node with a UE form factor, to serve as an intermediary between a cell and a UE. Relays may be served by cells on the relays' backhaul links, on which the relays behave similarly to regular UEs. Relays may serve UEs on access links, on which relays behave similarly to cells. Backhaul and access links may be separated in frequency (e.g., backhaul link on frequency f₁ and access link on frequency f₂) to avoid the need for half-duplex operation. Relays which operate their backhaul links and access links on separate frequencies are often referred to as out-of-band relays. Aspects of the present disclosure focus on such out-of-band relays, although the concepts described may be extended to in-band relays, i.e. relays which operate their backhaul links and access links on the same frequencies.

Capacity gains in opportunistic relaying may result primarily from an opportunistic selection gain. A large number of candidate relays may be deployed, among which only a small subset are activated and actually serve as relays. The selection step may be crucial to performance, as the selected relays should be in excellent channel conditions, e.g., in terms of high backhaul quality, to achieve high capacity gains. Regular UEs, some of which experience poor channel conditions when connecting to a macro cell, therefore benefit from associating with relays that achieve much higher backhaul quality.

The reasons for achieving higher backhaul spectral efficiency may include the locations of the relays. More importantly, however, the gains may come from being located in favorable propagation conditions. The downselection of relays (i.e., selection of some relays to activate from the set of all available relays) may result in a statistical gain from selecting only the best few relays that happen to be in such favorable conditions. Relays and the UEs the relays serve may therefore benefit from an opportunistic gain resulting from the downselection process.

According to certain aspects of the present disclosure, the concepts of MPE and opportunistic relays may be combined to achieve performance gains in cellular communications. In particular, opportunistic relay activation may help to avoid MPE's performance limitations for UEs that are impacted by a larger number of interferers than the number of interferers for which the UEs can report CSI. According to certain aspects, such UEs may associate with a relay that is impacted by fewer interferers and for which interference nulling can be performed with good accuracy.

According to certain aspects, combining MPE and opportunistic relays may hinge on at least two critical factors including predicting post-MPE performance for both regular (non-relay) UEs and candidate relays, and choosing relays to activate and which UEs to associate with the relays.

According to certain aspects, a cell may operate using both MPE and opportunistic activation of relays, and may predict post-MPE performance of served UEs and candidate relays to use in making determinations of candidate relays to activate. For example, a cell serving eight UEs and three candidate relays may predict good performance for six of the UEs and all three candidate relays under MPE. In the example, the cell may predict poor performance for the remaining two UEs under MPE, and determine to serve the remaining two UEs with relays.

According to certain aspects, a cell may determine to activate certain relays and associate UEs (i.e., serve the UEs) with the relays, while leaving other relays deactivated. For example, a cell may serve eight UEs and three candidate relays, and may determine to serve two UEs with relays. In the example, the cell may determine to serve each of the two UEs with one relay and activate those relays, while determining to deactivate the third relay.

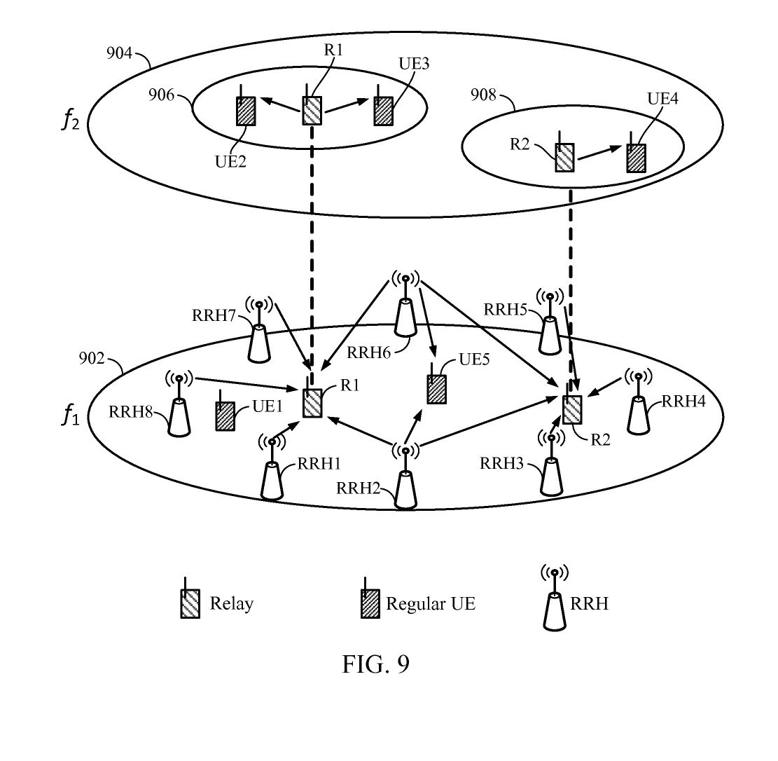

FIG. 9 illustrates an exemplary deployment architecture, according to certain aspects. The architecture consists of two layers 902 and 904 associated with frequency bands f₁ and f₂, respectively. On f₁, a number of remote-radio-heads (RRHs) that are interconnected by a fiber backhaul, i.e., a “Cloud RAN,” perform MPE to serve a combination of UEs and relays. UEs such as UE1 and UE5 may be directly served by RRHs (e.g., RRH2 and RRH6) on f₁, may not make use of relays, and may not be active on f₂. RRHs may provide a backhaul link on f₁ for activated relays R1 and R2. For example, RRH1, RRH2, RRH6, RRH7, and RRH8 may provide a backhaul link on f₁ for R1.

According to certain aspects, activated relays R1 and R2 may act as base stations on f₂ and serve their associated UEs, such as UE2, UE3, and UE4. UEs served by relays are referred to as terminal UEs. The coverage areas of the activated relays may be smaller than the coverage area of the cell. For example, the coverage area of R1 may be the area 906, while the coverage area of R2 may be the area 908. MPE may not be performed on f₂, if a fast backhaul among the relays is lacking. Instead, relays may perform reuse-1 transmission with a fixed power level on f₂. For example, activated relays may transmit on f₂ at a power level selected to prevent interference to other activated relays and that may be lower than the power level used by the relays and the RRHs on f₁.

Activation of certain relays may create harsh interference conditions between those relays on the access link (e.g., on f₂ in FIG. 9). According to certain aspects of the present disclosure, a relay activation procedure may avoid scenarios in which such strong access link interference would occur. For example, a relay activation procedure may consider the physical locations of the relays and activate only relays which have sufficient spatial separation to avoid causing strong access link interference to each other.

According to certain aspects, relays may not have any traffic of their own but may act only as intermediaries between the RRHs and their associated terminal UEs. For example, a relay activation procedure may refer to scheduling information for RRHs in the cell and ensure that UEs scheduled by the RRHs to transmit or receive the UEs' own data are not activated as relays.

Referring to FIG. 9, each of the UEs may be associated with either one of the RRHs or with a single relay. In the former case, a UE may be referred to as a direct UE which is active only on f₁. In the latter case, a UE may be referred to as a terminal UE active on f₂ and associated with a single relay, which may be selected from among a large number of candidate relays, in accordance with certain aspects of the present disclosure.

According to certain aspects, a relay activation algorithm may be selected to consider at least three factors, including anticipated post-MPE performance of candidate relays on f₁, anticipated interference created on f₂ by candidate relays, and anticipated load on the candidate relays.

Anticipated post-MPE performance of candidate relays may depend on backhaul quality available to candidate relays. An algorithm to select relays for activation may be selected so as to ensure each selected relay does not contend for backhaul capacity with each other relay selected for activation, for example.

Anticipated interference created on f₂ by candidate relays may depend on spatial separation of selected relays. An algorithm to select relays for activation may be selected so as to ensure each selected relay is a minimum distance away from each other relay selected for activation, for example.

Anticipated load on the candidate relays may depend on the number of UEs supported by each relay. An algorithm to select relays for activation may be selected so as to ensure that each selected relay only supports one UE, for example. By so selecting the relays, the algorithm could ensure that multiple UEs do not share the limited backhaul capacity of a single relay.

According to certain aspects, RRHs may be interconnected by a fiber-based backhaul, such that the RRHs may effectively act as a distributed antenna array used with a centralized scheduler. According to certain aspects, at least one UE may be scheduled per RRH by the centralized scheduler, to avoid a dimension loss associated with fewer scheduling opportunities.

According to certain aspects, in a relay activation algorithm, RRHs may each schedule at least one of the RRH's served UEs in every subframe. Next, to determine the precoding vectors for joint transmission, a system-wide channel matrix may be constructed based on the CSI reported by the scheduled UEs. Mathematically, the system-wide channel matrix H can be expressed as

$$H = [ \text{?} ] \text{?}$$

$$\text{?} \text{indicates text missing or illegible when filed}$$

where hᵢⱼ denotes the channel between the i-th scheduled UE and the j-th RRH. According to certain aspects, the number of scheduled UEs M may be constrained to be smaller than the degrees-of-freedom available in the network, which is a constraint that may be satisfied by scheduling no more than a given number of UEs per RRH.

According to certain aspects, if each UE reports CSI for all RRHs in the system, the system-wide channel matrix may be constructed in full. Further, since hᵢⱼ's are random, the matrix H almost certainly has a pseudo-inverse. By using a linear precoder W that corresponds to this pseudo-inverse, the multi-point channel may be inverted perfectly. That is, the vector of received symbols y, where yᵢ corresponds to the i-th scheduled UE, may be written as:

y=HWx=HH⁺x=Ix

where x denotes a vector of symbols to be conveyed, H⁺ denotes the pseudo-inverse, and I the identity matrix.

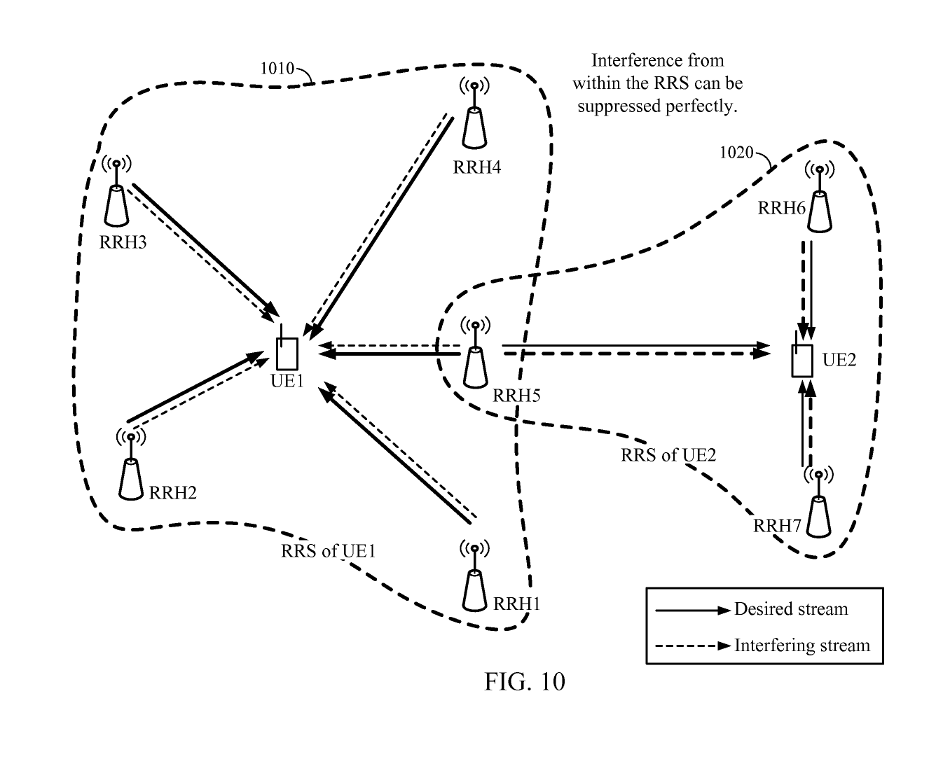

FIG. 10 illustrates RRHs performing Multi Point Equalization (MPE), in accordance with aspects of the present disclosure. According to certain aspects, UEs may be unable to report CSI for all RRHs in the network. This is illustrated in FIG. 10, where UE1 and UE2 unable to report CSI for all seven RRHs. UE1 and UE2 may be respectively constrained to report CSI only for the indicated subset of RRHs, referred to as their radio reporting set (RRS). That is, UE1 may be constrained to report CSI only for UE1's RRS 1010 (RRH1, RRH2, RRH3, RRH4 and RRH5), while UE2 may be constrained to report CSI only for UE2's RRS 1020 (RRH5, RRH6, and RRH7). RRHs contained in a UE's RRS may be able to perform linear precoding such that their transmissions coherently combine at the UE. RRHs outside the radio reporting set may not be able to perform the same linear precoding; however, they may still transmit a UE's data in such a manner as to null interference created by cells in the RRS. This is illustrated in FIG. 10 for UE2, where RRH6 and RRH7, though not in UE1's RRS, transmit UE1's data in such a manner as to null out the interference of RRH5 at UE2, which is simultaneously scheduled. It is also illustrated in FIG. 10 for UE1, where RRH1, RRH2, RRH3, and RRH4 all transmit UE2's data in such a manner as to null out the interference of RRH5 at UE1.

According to certain aspects, MPE performance may improve with increasing RRS size and accuracy of the CSI feedback. For example, a cell performing MPE using six RRHs may configure each of two UEs with an RRS of three RRHs. In the example, the cell may reconfigure each of the two UEs with an RRS including all six RRHs in order to improve performance of the system.

According to certain aspects, an MPE system may benefit from having multiple transmit antennas per RRH and/or multiple receive antennas per UE. Such multi-antenna aspects may be incorporated into the interference nulling algorithm by associating rows of H with receive antennas (instead of UEs) and columns of H with transmit antennas (instead of RRHs). For example, if a cell, such as the one in FIG. 10, is using MPE and each RRH has two antennas, then the cell would construct a channel matrix H with fourteen (seven RRHs with two antennas each) columns. In the example, if the cell schedule six UEs, each having one antenna, and two UEs, each having two antennas. In the example, the cell would construct a channel matrix H of ten (e.g., six UEs with one antenna each and two UEs with two antennas) rows and twelve (six RRHs with two antennas each) columns.

According to certain aspects, MPE may utilize various CSI feedback frameworks, including implicit or explicit frameworks. For example, a cell using MPE serving seven UEs may schedule the UEs utilizing explicit CSI feedback (e.g., an aperiodic CSI report) from five of the UEs and implicit CSI feedback (e.g., an indication that CSI has not changed since it was last reported) from the other two UEs.

According to certain aspects, MPE precoding algorithms may not be limited to computing the pseudo-inverse of the system-wide channel matrix. Other algorithms may also be considered, e.g., based on maximizing signal-to-leakage ratio. The latter algorithm has the benefit of striking a tradeoff between interference nulling to victim cells and maximizing signal energy to the target UE.

According to certain aspects, opportunistic activation of a few relays, selected from a large candidate set, may be performed. According to these aspects, opportunistic relay selection may be performed at a slow time scale and may not take into account fast fading, or dynamic interference variations. Rather, long-term channel measurements (similar to long-term receive power) may be used to both predict post-MPE performance on f₁ and access link performance (assuming full frequency reuse) on f₂. The opportunistic selection may be performed in a centralized fashion based on long-term UE reports. For example, a cell using opportunistic relay selection may be based on an average of CSI reports received from UE1 and UE 2 during a most recent five-minute period, rather than using only the most recent CSI report from each UE.

According to certain aspects, relay activation may be performed based on a large set of candidate relays which may be idle prior to activation. According to these aspects, post-MPE performance cannot be based on actual performance in past subframes. Rather, post-MPE performance may be predicted based on long term metrics, such as the received power levels from nearby cells. For example, a cell using opportunistic relay selection may select relays to activate and UEs to be served by the relays in each scheduling interval based on received power levels from nearby cells, rather than selecting relays and served UEs based on the actual performance in the previous scheduling interval.

According to certain aspects, interference originating from outside the RRS may not be mitigated by MPE. For example, in a cell using MPE, such as the cell in FIG. 10, transmissions from RRH6 and RRH7 may interfere with transmissions to UE1, but because RRH6 and RRH7 are not in UE1's RRS, the interfering transmissions from RRH6 and RRH7 will not be nulled or otherwise mitigated by the use of MPE.

According to certain aspects, degradation resulting from imperfect CSI estimation may be determined from long-term performance of the network elements. For example, in a cell using opportunistic relay activation, a central scheduler may track block error rates (BLER) associated with use of each relay, and determine an estimate of errors in CSI estimates from each relay based on an average of the tracked block error rates.

According to certain aspects, not all of the energy associated with the transmission of a UE's data stream is spent on beamforming to that UE. According to these aspects, a portion of the energy is spent on nulling interference for other UEs. The breakdown of power in this respect may depend on the instantaneous composition of the system-wide channel matrix, which includes the co-scheduling decisions of other UEs. According to certain aspects, the portion of energy spent on nulling interference for other UEs may not be predicted, but may be accounted for by using a backoff factor compared to the power level that would be achieved with ideal eigen-beamforming from RRHs in the RRS to that UE.

Referring to FIG. 10 as an example, a cell with seven RRHs using MPE may schedule two UEs (e.g., UE1 and UE2) for simultaneous reception of data. In the example, four RRHs may be in UE1's RRS, while three RRHs may be in UE2's RRS. In the example, the cell may determine a power level for transmission to UE1 from RRH1, RRH2, RRH3, RRH4, and RRH5 (the RRHs in UE1's RRS), and then determine a power level to use for nulling interference from the RRHs in UE2's RRS (RRH5, RRH6, and RRH7) equal to the transmission power level of each RRH reduced by a constant value (e.g., 6 dB).

FIG. 11 illustrates example operations 1100 that may be performed in accordance with certain aspects of the present disclosure. The operations 1100 begin, at 1102, by identifying at least one UE capable of being served by a plurality of transmission points (TPs) on a first frequency or by a relay on a second frequency. At 1104, evaluating a first performance metric conditioned on the UE being served by the relay and a second performance metric conditioned on the UE being served by the plurality of TPs may be performed. At 1106, deciding whether the UE should be served by the plurality of TPs on the first frequency or by the relay on the second frequency, based, at least in part, on the first and second performance metrics may be performed. At 1108, taking action to switch the UE to or from being served by the relay or the plurality of TPs, based on the decision, may be performed.

According to certain aspects, taking action to switch the UE to or from being served by the relay or the plurality of TPs may include activating the relay to serve the UE currently served by the plurality of TPs. For example, a cell may determine to switch a UE from being served by a group of TPs (e.g., RRHs) to a UE-type relay which is currently inactive, and the cell may send a command to activate the UE-type relay before sending a command to switch the UE to the UE-type relay.

According to certain aspects, taking action to switch the UE to or from being served by the relay or the plurality of TPs may include deactivating the relay currently serving the UE. For example, a cell may determine to switch a UE from being served by a UE-type relay to a group of TPs (e.g., RRHs), and the cell may send a command to deactivate the UE-type relay after sending a command to switch the UE to the group of TPs.

According to certain aspects, a set of UEs in a cell may be considered for association with relays. According to these aspects, an iterative process of considering each UE in turn for association with one of a set of relays may be performed to determine which relays to activate and which UEs to associate with each relay. For example, a cell may be serving four UEs. In the example, the cell may calculate the performance of the UE with each of a set of relays and determine whether to associate the UE directly with the cell or with a relay, and which relay, before proceeding to the next UE in the list and performing similar calculations for that UE. In the example, the call may perform similar calculations for all UEs in the list before sending commands to change the association of any of the UEs, if the cell determines that any associations should be changed.

According to certain aspects, UEs may be ordered in increasing order of post-MPE signal to interference and noise ratios (SINRs) relative to at least one of TPs or relays. According to these aspects, UEs with lower post-MPE signal to interference and noise ratios (SINRs) may be considered for associating with relays before UEs with higher post-MPE signal to interference and noise ratios (SINRs).

According to certain aspects, candidate relays to evaluate may be identified based on path loss to the UE. For example, a cell may consider whether to change the association of a served UE. To determine whether to switch the UE to a relay and which relay to use, the cell may evaluate the performance of the UE with each relay in a set of relays. In the example, the cell may order all relays in the cell in increasing order of path loss from the relay to the UE, and then select a subset of the relays (e.g., the first ten relays of the ordered list) and calculate performance of the UE when associated to each relay in the subset. The cell may then select to associate the UE with the relay which offers the greatest increase in performance, if any.

According to certain aspects, if the expected backhaul quality of a candidate relay exceeds that of the UE by a certain factor, the relay may be activated and the UE associated with the relay. According to these aspects, if no such relay exists, the UE will remain associated directly with the cloud RAN on f₁. For example, a cell may calculate the expected quality of a relay's backhaul link and compare it to the expected quality of an access link of a UE when associated with a cloud RAN (i.e., a set of RRHs), and if the expected quality of the relay's backhaul link is not a factor α (e.g., 1.25) greater than the UE's expected access link quality, then the cell may determine to associate the UE directly with the cloud RAN.

According to certain aspects, a predicted utility metric may be associated with each candidate relay association decision. For example, a cell may be serving four UEs. In the example, the cell may calculate a predicted system-wide utility metric based on associating the UE with each of a set of relays. In the example, the cell may determine whether to associate the UE directly with the cell or with a relay, and which relay, based on the utility metric predictions before proceeding to the next UE in the list and performing similar calculations for that UE. In the example, the call may perform similar calculations for all UEs in the list before sending commands to change the association of any of the UEs, if the cell determines that any associations should be changed.

According to certain aspects, an access link constraint may be considered in a system-wide scheduling forecast associating a predicted system-wide utility metric with each candidate relay association decision. According to these aspects, an access link constraint may be explicitly considered in determining relays to activate and UEs to associate with those relays. An access link constraint may be considered by adding a constraint that each relay may not be provided more capacity on the relay's backhaul link than the relay can disseminate on the relay's access link when predicting the system-wide utility metric.

According to certain aspects, a backhaul link constraint may be considered in a system-wide scheduling forecast associating a predicted system-wide utility metric with each candidate relay association decision. According to these aspects, a backhaul link constraint may be explicitly considered in determining relays to activate and UEs to associate with those relays. A backhaul link constraint may be considered by adding a constraint that each relay may not schedule UEs with a rate larger than each relay's corresponding backhaul link capacity when predicting the system-wide utility metric.

According to certain aspects, an access link constraint and a backhaul link constraint may both be considered in a system-wide scheduling forecast associating a predicted system-wide utility metric with each candidate relay association decision. An access link constraint and a backhaul link constraint may be taken into account by running an optimization problem once for RRHs and once for activated relays and using the results to determine whether the backhaul link or the access link is more limiting in the scheduling of UEs on each activated relay. When predicting the system-wide utility metric for a particular relay, the results of the optimization problem may be used to determine whether to use a backhaul link constraint or an access link constraint in predicting the system-wide utility metric. For example, a cell with six RRHs may perform opportunistic relay activation using a predicted system-wide utility metric to determine relay association decisions. In the example, the cell may determine three candidate relays to consider for a served UE. In the example, the cell may run an optimization problem on the six RRHs, and then run a second optimization problem on the three candidate relays. In the example, the cell may determine, based on the optimization problems, that the first candidate relay is constrained by its access link, while the second and third candidate relays are constrained by their backhaul links. In the example, the cell may calculate the system-wide utility metric for the first candidate relay based on limiting scheduling of the UE according to the first candidate relay's access link, and the cell may calculate the system-wide utility metric for the second and third candidate relays based on limiting scheduling of the UE according to each candidate relay's backhaul link.

According to certain aspects, candidate relays to evaluate may be identified based, at least in part, on a predefined value for a forecasted transmission rate to the UE. For example, a cell performing opportunistic relay activation may forecast a transmission rate to a UE. In the example, the cell may determine a backhaul link and access link constraint for each relay and identify relays as candidate relays for the UE based on the relay's access link and backhaul link constraints equaling or exceeding the forecasted transmission rate to the UE.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications, comprising:
identifying at least one UE capable of being served by a plurality of transmission points (TPs) on a first frequency or by a relay on a second frequency;
evaluating a first performance metric conditioned on the UE being served by the relay and a second performance metric conditioned on the UE being served by the plurality of TPs;
deciding whether the UE should be served by the plurality of TPs on the first frequency or by the relay on the second frequency, based, at least in part, on the first and second performance metrics; and
taking action to switch the UE to or from being served by the relay or the plurality of TPs, based on the decision.

2. The method of claim 1, wherein the taking action comprises: activating the relay to serve the UE currently served by the plurality of TPs.

3. The method of claim 1, wherein the taking action comprises: deactivating the relay currently serving the UE.

4. The method of claim 1, wherein:
the at least one UE comprises a set of UEs; and
the evaluating comprises ordering UEs in the set based on signal to interference and noise ratios (SINRs) relative to at least one of TPs or relays and evaluating candidate relays for UEs, based on the ordering, starting with UEs having lowest SINR.

5. The method of claim 1, further comprising: identifying candidate relays to evaluate based on path loss to the UE.

6. The method of claim 1, wherein the evaluating comprises calculating a first metric for each of a set of candidate relays and selecting the relay, based on the calculated first metrics.

7. The method of claim 1, wherein at least one of the first and second metrics comprises a metric that corresponds to system-wide utility.

8. The method of claim 1, wherein the evaluating comprises forecasting scheduling of transmissions by the relay.

9. The method of claim 1, further comprising identifying a candidate set of relays to evaluate for the UE based, at least in part, on a predefined value for a forecasted transmission rate to the UE.

10. The method of claim 1, wherein the relay comprises another UE.

11. The method of claim 1, wherein the evaluating comprises determining the relay will not interfere with another relay.

12. The method of claim 1, further comprising identifying candidate relays from among UEs which are not scheduled to transmit or receive data other than data to be relayed.

13. An apparatus for wireless communications, comprising:
a processor configured to
identify at least one UE capable of being served by a plurality of transmission points (TPs) on a first frequency or by a relay on a second frequency,
evaluate a first performance metric conditioned on the UE being served by the relay and a second performance metric conditioned on the UE being served by the plurality of TPs,
decide whether the UE should be served by the plurality of TPs on the first frequency or by the relay on the second frequency, based, at least in part, on the first and second performance metrics, and
take action to switch the UE to or from being served by the relay or the plurality of TPs, based on the decision; and
a memory coupled with the processor.

14. The apparatus of claim 13, wherein taking action comprises: activating the relay to serve the UE currently served by the plurality of TPs.

15. The apparatus of claim 13, wherein taking action comprises: deactivating the relay currently serving the UE.

16. The apparatus of claim 13, wherein:
the at least one UE comprises a set of UEs; and
the evaluating comprises ordering UEs in the set based on signal to interference and noise ratios (SINRs) relative to at least one of TPs or relays and evaluating candidate relays for UEs, based on the ordering, starting with UEs having lowest SINR.

17. The apparatus of claim 13, wherein the processor is further configured to identify candidate relays to evaluate based on path loss to the UE.

18. The apparatus of claim 13, wherein evaluating comprises calculating a first metric for each of a set of candidate relays and selecting the relay, based on the calculated first metrics.

19. The apparatus of claim 13, wherein at least one of the first and second metrics comprises a metric that corresponds to system-wide utility.

20. The apparatus of claim 13, wherein evaluating comprises forecasting scheduling of transmissions by the relay.

21. The apparatus of claim 13, wherein the processor is further configured to identify a candidate set of relays to evaluate for the UE based, at least in part, on a predefined value for a forecasted transmission rate to the UE.

22. The apparatus of claim 13, wherein the relay comprises another UE.

23. The apparatus of claim 13, wherein evaluating comprises determining the relay will not interfere with another relay.

24. The apparatus of claim 13, wherein the processor is further configured to identify candidate relays from among UEs which are not scheduled to transmit or receive data other than data to be relayed.

25. An apparatus for wireless communications, comprising:
means for identifying at least one UE capable of being served by a plurality of transmission points (TPs) on a first frequency or by a relay on a second frequency;
means for evaluating a first performance metric conditioned on the UE being served by the relay and a second performance metric conditioned on the UE being served by the plurality of TPs;
means for deciding whether the UE should be served by the plurality of TPs on the first frequency or by the relay on the second frequency, based, at least in part, on the first and second performance metrics; and
means for taking action to switch the UE to or from being served by the relay or the plurality of TPs, based on the decision.

26. A program product for wireless communication, comprising a computer readable medium having instructions stored thereon for:
identifying at least one UE capable of being served by a plurality of transmission points (TPs) on a first frequency or by a relay on a second frequency;
evaluating a first performance metric conditioned on the UE being served by the relay and a second performance metric conditioned on the UE being served by the plurality of TPs;
deciding whether the UE should be served by the plurality of TPs on the first frequency or by the relay on the second frequency, based, at least in part, on the first and second performance metrics; and
taking action to switch the UE to or from being served by the relay or the plurality of TPs, based on the decision.
